(19) United States
(12) Patent Application Publication
(10) Pub. No.: US 2026/0339083 A1
(43) Pub. Date: Oct. 29, 2026

(54) MICROSCOPE OBJECTIVE, IN PARTICULAR FOR A DEVICE FOR DETERMINING THE POSITION OF STRUCTURES ON A MASK FOR MICROLITHOGRAPHY

(71) Applicant: Carl Zeiss SMT GmbH, Oberkochen (DE)

(72) Inventor: Alexander Epple, Aalen (DE)

(21) Appl. No.: 19/637,426

(22) Filed: Apr. 2, 2026

(30) Foreign Application Priority Data
Apr. 28, 2025 (DE) 102025116220.4

(51) Int. Cl. G02B 21/00; G02B 3/00; G02B 21/02; G02B 21/16; G02B 21/33

(52) U.S. Cl. CPC G02B 21/0016; G02B 21/02; G02B 21/16; G02B 21/33; G02B 2003/0093

(57) ABSTRACT

The invention relates to a microscope objective, in particular for a device for determining the position of structures on a mask for microlithography, wherein the microscope objective is designed for an operating wavelength (λ) of less than 190 nm and for light having a bandwidth of less than 5 pm, wherein the object-side numerical aperture (NA) of the microscope objective is at least 0.8, and wherein at least one meniscus lens is provided for at least partial correction of spherical aberration.

### CROSS-REFERENCE TO RELATED APPLICATION

This application claims priority of German Patent Application DE 10 2025 116 220.4, filed on Apr. 28, 2025, the content of which is hereby incorporated by reference in its entirety.

### TECHNICAL FIELD

The invention relates to a microscope objective, in particular for a device for determining the position of structures on a mask for microlithography.

### BACKGROUND

Microlithography is used for producing microstructured components, such as integrated circuits or liquid crystal displays (LCDs). The microlithography process is carried out in a so-called projection exposure apparatus comprising an illumination device and a projection lens. The image of a mask (=reticle) illuminated by use of the illumination device is in this case projected by use of the projection lens onto a substrate (e.g., a silicon wafer) coated with a light-sensitive layer (photoresist) and arranged in the image plane of the projection lens, in order to transfer the mask structure to the light-sensitive coating of the substrate.

Mask inspection systems are used to inspect the mask used in the microlithography process or to characterize the structures present on the mask. This characterization is performed both with regard to existing deviations of the respective structure on the mask from the target position specified by the design (so-called placement error or “registration error,” referring to: “registration”) and with regard to the minimum (critical) line width of the structures (CD=“critical dimension”). The mask is imaged onto a detector using a high-resolution microscope objective with high magnification (e.g., 300-500×).

Given the high accuracy requirements applicable to the microlithography process, the provision of a microscope objective of sufficient resolution in the context of characterizing the structures present on the mask is in practice an increasingly demanding challenge.

In microlithographic optical systems (projection exposure apparatuses or mask inspection systems) designed for operation in the DUV range (e.g., at operating wavelengths of less than 400 nm, in particular less than 250 nm), use is typically made of laser light sources in the form of excimer lasers, e.g., krypton fluoride excimer lasers at an operating wavelength of approximately 248 nm or argon fluoride excimer lasers at an operating wavelength of approximately 193 nm. In principle, a significant increase in resolution is conceivable by significantly reducing the operating wavelength and/or by significantly increasing the numerical aperture (e.g., by providing an immersion system).

In practice, however, problems arise here inter alia on account of the limitations imposed with a shorter operating wavelength with regard to the optical materials available in the optical system with sufficient transmission, where especially in the spectral range below 190 nm, quartz glass (SiO₂)—which is customary at the aforementioned operating wavelengths of approximately 248 nm or 193 nm—is no longer usable.

A further challenge in providing microscope objectives for mask characterization arises from the bandwidth of the light source used, since if bandwidth filtering is not available, even values of the bandwidth in the range of a few picometers (pm) necessitate possibly complex correction of chromatic aberrations. The bandwidth of a light source should be understood here to mean the FWHM (FWHM=full width at half maximum). However, the realization of concepts commonly used for this purpose, such as the combined use of diverging and converging lenses composed of materials with significantly different dispersion, is in turn hampered by the abovementioned restrictions regarding available optical materials in the range of shorter operating wavelengths.

In respect of the prior art, reference is made purely by way of example to DE 39 15 868 C2, WO 2008/019803 A1, US 2009/0034061 A1, U.S. Pat. No. 7,187,503 B2, WO 01/50171 A1, U.S. Pat. No. 6,362,923 B1, U.S. Pat. No. 7,075,721 B2, U.S. Pat. No. 6,757,051 B2, US 2008/0198353 A1, WO 2004/053534 A2, and also the publications: J. Mulkens et al.: “Benefits and limitations of immersion lithography,” J. Microlith., Microfab., Microsyst., Vol. 3 No. 1, 1-11 (2004) [DOI: 10.1117/1.1636768] und L. Schupmann, “On short-focal-length medial telescopes,” Zeitschrift für Instrumentenkunde, Vol. XXXIII pages 308-312 (1913).

### SUMMARY

It is an aspect of the present invention to provide a microscope objective, in particular for a device for determining the position of structures on a mask for microlithography, which enables a significant increase in resolution while taking into account the above problems.

This aspect is achieved in accordance with the features of independent Patent Claim 1.

In accordance with one aspect, the invention relates to a microscope objective, in particular for a device for determining the position of structures on a mask for microlithography, wherein the microscope objective is designed for an operating wavelength (λ) of less than 190 nm and for light having a bandwidth (FWHM) of less than 5 pm,
wherein the object-side numerical aperture (NA) of the microscope objective is at least 0.8, and
wherein at least one meniscus lens is provided for at least partial correction of spherical aberration.

In embodiments of the invention, the microscope objective is designed in particular for light having a bandwidth of less than 2 pm.

The criterion that the microscope objective is designed for light having a bandwidth (FWHM) of less than 5 pm (or less than 2 pm) means that it is only for light with a spectral bandwidth (FWHM) of less than 5 pm (or less than 2 pm) that the so-called Strehl number (also referred to as Strehl ratio or Strehl intensity ratio) reaches a value of at least 80% (so that the optical system can still be regarded as substantially diffraction-limited). The Strehl number is defined as the ratio of the maximum intensity of a point source in the image plane as observed in the PSF profile (PSF=“Point Spread Function”) to the theoretical maximum intensity of a perfect diffraction-limited optical system.

The invention is based in particular on the concept of realizing a microscope objective for a mask inspection system pertaining to microlithography of high optical resolution and at the same time with comparatively low complexity.

For this purpose, the necessity of achromatization and any associated outlay for the correction of chromatic aberrations (for instance by using materials with different dispersion) are avoided according to the invention, firstly, by the use of a quasi-monochromatic light source (i.e., a light source with a particularly narrow spectral bandwidth). Owing to achromatization being dispensed with, it is sufficient in particular for the microscope objective according to the invention to be configured as a “one-material system.” At the same time, there is also no need for other complexity-increasing components for chromatic correction (such as mirrors, for instance).

Secondly, according to the invention, the transition to a shorter operating wavelength (below 190 nm) in order to achieve a high resolution is combined with a high numerical aperture (optionally using immersion), while at the same time spherical aberration, which is problematic as the numerical aperture increases, is sufficiently corrected by the use of at least one meniscus lens.

In this case, the invention proceeds from the consideration, inter alia, that the step to operating wavelengths of less than 190 nm (in particular operating wavelengths of less than 180 nm, more particularly less than 170 nm) is associated with a limitation regarding the materials that are still usable in the optical design (i.e., are still sufficiently transmissive for the respective operating wavelength), which in turn makes it difficult to correct the longitudinal chromatic aberration in the manner required in conjunction with a significant bandwidth of the light source used. It should be noted that correction of the longitudinal chromatic aberration is mandatory if the bandwidth of the light source has or exceeds a value of a few picometres. In this respect, the invention pursues the approach of departing from conventional configurations of microscope objectives, in which the imaging typically takes place over a comparatively wide spectral range, and designing the microscope objective according to the invention from the outset for a specific wavelength and thus achieving a significant reduction in outlay.

In accordance with one embodiment, the at least one meniscus lens is arranged at a position at which the marginal ray height is greater than 70%, in particular greater than 75%, of the maximum marginal ray height.

In accordance with one embodiment, the microscope objective is designed for an operating wavelength (λ) of less than 180 nm, in particular less than 170 nm, more particularly less than 160 nm.

In accordance with one embodiment, the object-side numerical aperture (NA) of the microscope objective is at least 1.0, in particular at least 1.2.

In accordance with one embodiment, the microscope objective has an immersion medium between the last lens on the object plane side and the object plane (OP), said immersion medium having a refractive index of at least 1.3 at the operating wavelength (λ).

The immersion medium can be in particular perfluoropolyether (=PFPE). In this context, reference is made to the following publication: J. Mulkens et al.: “Benefits and limitations of immersion lithography,” J. Microlith., Microfab., Microsyst., Vol. 3 No. 1, 1-11 (2004) [DOI: 10.1117/1.1636768].

The disadvantages associated with the use of an immersion medium are deliberately accepted in order in return to achieve the greater optical resolution associated with the increase in numerical aperture that is made possible as a result.

In accordance with one embodiment, the microscope objective has a last lens on the object plane side composed of a material which has a refractive index of at least 1.8, in particular at least 2.0, at the operating wavelength.

In accordance with one embodiment, between a last optical surface of the microscope objective on the object plane side and the object plane (OP) there is a distance of less than λ, in particular less than λ/2, more particularly less than λ/5.

In accordance with one embodiment, the microscope objective comprises exclusively a single optical material.

In accordance with one embodiment, the microscope objective has a dioptric construction.

The invention furthermore also relates to a device for determining the position of structures on a mask for microlithography, wherein the device comprises a microscope objective having the features described above.

In accordance with one embodiment, the device has a light source having a bandwidth (FWHM) of less than 5 pm, in particular less than 2 pm.

Further configurations of the invention can be gathered from the description and the dependent claims.

The invention is explained in greater detail below on the basis of exemplary embodiments illustrated in the accompanying figures.

### BRIEF DESCRIPTION OF DRAWINGS

In the figures:

FIG. 1A shows a schematic illustration of a dioptric microscope objective in accordance with a first embodiment of the invention;

FIG. 1B shows, for the microscope objective from FIG. 1A, an achievable PSF profile as a section through the diffraction pattern of a point in the field center of the image field;

FIG. 1C shows a schematic illustration for explaining the possible use of the microscope objective from FIG. 1A in combination with a tube system;

FIG. 1D shows a schematic illustration which in combination with FIG. 1C shows the use of the microscope objective from FIG. 1A together with a light source;

FIG. 1E shows a schematically depicted source spectrum for the light source from FIG. 1D; and

FIGS. 2-4 show schematic illustrations of further embodiments of a dioptric microscope objective according to the invention.

### DETAILED DESCRIPTION

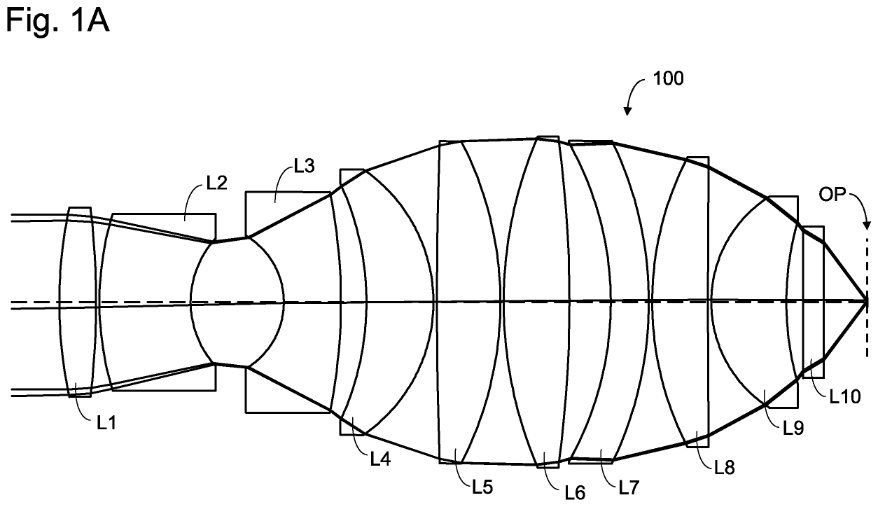

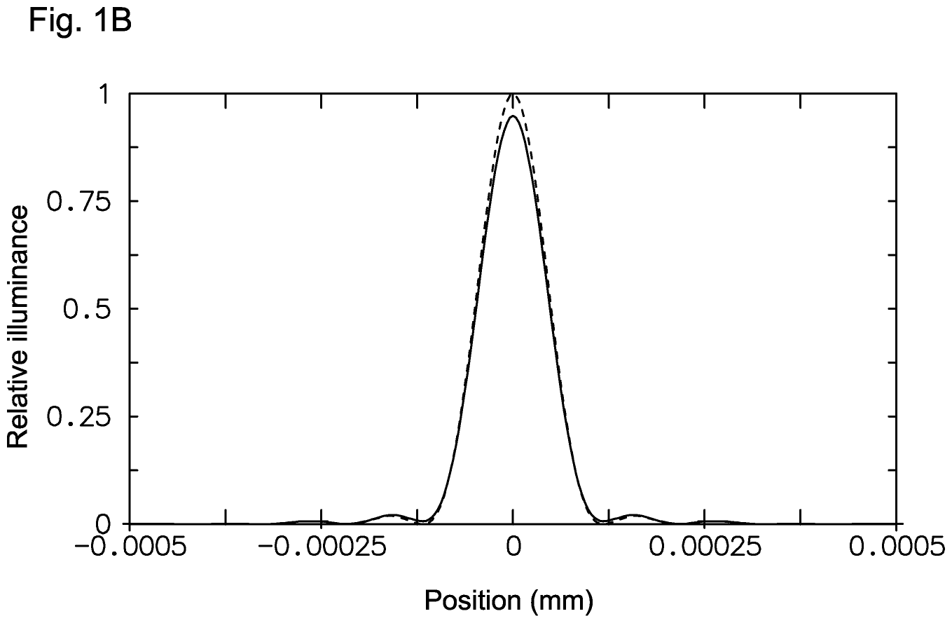

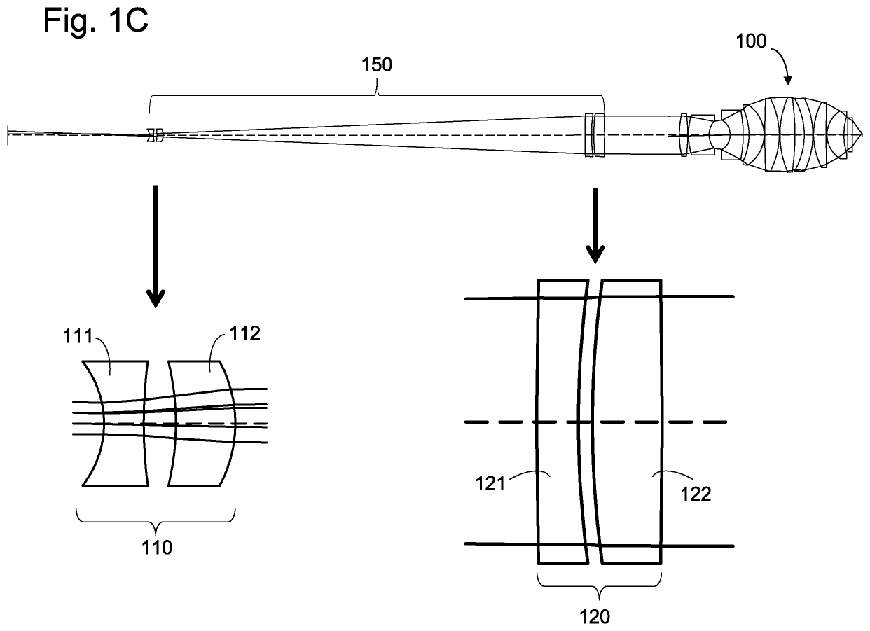

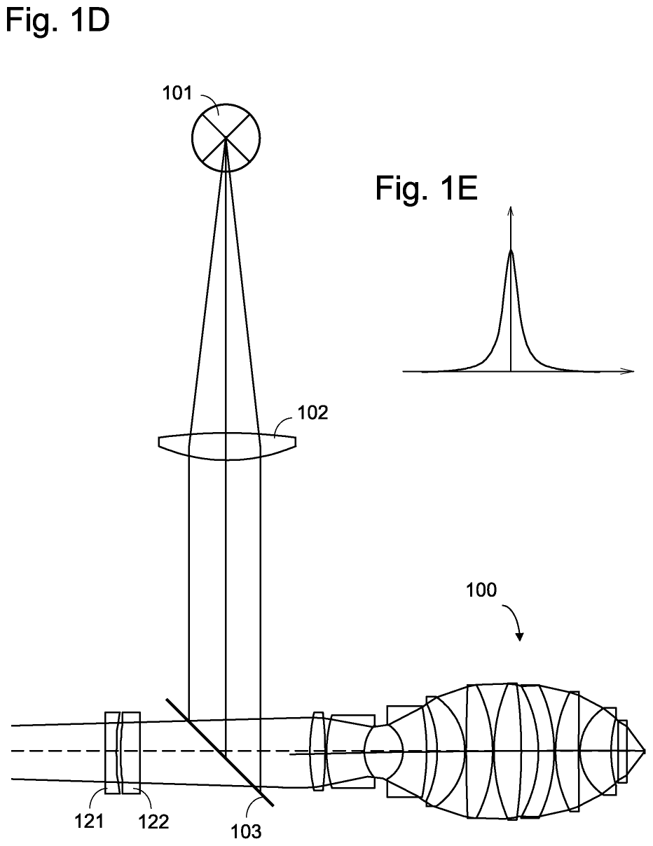

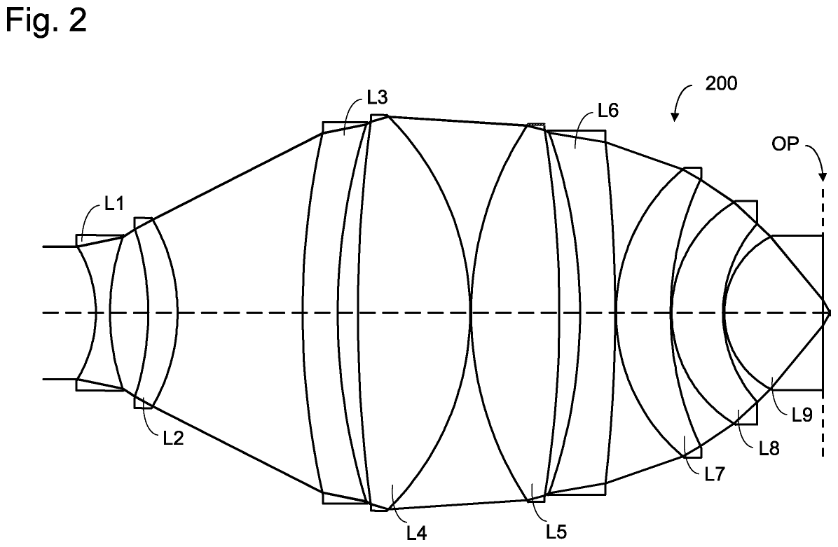

Various embodiments of a microscope objective according to the invention are described below with reference to the schematic (sectional) views in FIG. 1A to FIG. 4.

With regard to this detailed description of the exemplary embodiments in FIG. 1A to FIG. 4, it should first be pointed out that if the respective systems are intended to be used for high-aperture imaging of a lithographic mask (reticle), this mask or the corresponding object plane of the projection lens is situated at the right-hand end of the illustration and the actual imaging by the relevant system takes place from right to left. Notwithstanding this, however, both in FIGS. 1A to 4 and in the associated Tables 1 to 4 containing the specific design data, the optical elements or lenses are numbered for a beam path assumed—merely for the purposes of the description—in the opposite direction (that is to say from left to right).

What the embodiments described with reference to FIG. 1A to FIG. 4 have in common is that the requirement of achromatization and any associated outlay for the correction of chromatic aberrations are avoided by the use of a quasi-monochromatic light source (i.e., a light source with a particularly narrow spectral bandwidth). In particular, the respective microscope objective in the embodiments described with reference to FIG. 1A to FIG. 4 is configured as a “one-material system,” wherein no other components suitable for chromatic correction, such as mirrors or diffractive optical elements, are present either. Furthermore, in the embodiments, the transition to a shorter operating wavelength (in particular approximately 157 nm) in order to achieve a high resolution is in each case combined with a high numerical aperture (optionally using immersion), while at the same time spherical aberration (which is more problematic as the numerical aperture increases) is sufficiently corrected by the use of at least one meniscus lens.

All of the embodiments mentioned take account of the fact that owing to the transition to shorter operating wavelengths in the manner according to the invention, the selection of available, sufficiently transmissive optical materials is severely restricted (in which case, in particular, quartz (SiO₂), as commonly used at operating wavelengths of, e.g., 248 nm or 193 nm, is no longer available).

FIG. 1A shows in the lens sectional view a first exemplary embodiment of a microscope objective 100 with a purely refractive, dioptric construction, which has an object-side numerical aperture of NA=0.80. The associated design data are given at the end of the description of the figures, in Table 1. Inter alia, the values of the refractive indices of the optical material used for different wavelengths are also specified in order to clarify the dispersion profile.

The microscope objective 100 in accordance with FIG. 1A comprises a total of nine lenses L1-L9 composed of calcium fluoride (CaF₂), and also a plane-parallel end plate likewise composed of calcium fluoride (CaF₂), which is designated as “L10”. The end plate L10 can be used for sealing the optionally gas-filled microscope objective 100 with respect to the environment and also for metrology purposes, e.g., an optical distance determination between the plane underside and the substantially plane reticle. Depending on the specific use scenario, this end plate can also be omitted by simple adaptations to the optical design.

In the microscope objective 100 (when viewed “from left to right” as described above), a converging lens L1 is followed firstly by a diverging lens group composed of two lenses L2 and L3, whereby a significant increase in the cross-section of the beam is effected. This takes account of the large maximum lens diameter of the microscope objective 100 required for the comparatively high numerical aperture (NA).

The lens L7 situated in the region of the maximum lens diameters is configured as a meniscus lens that is convex on the object plane side and is virtually without refractive power, and this lens is primarily used to correct spherical aberration.

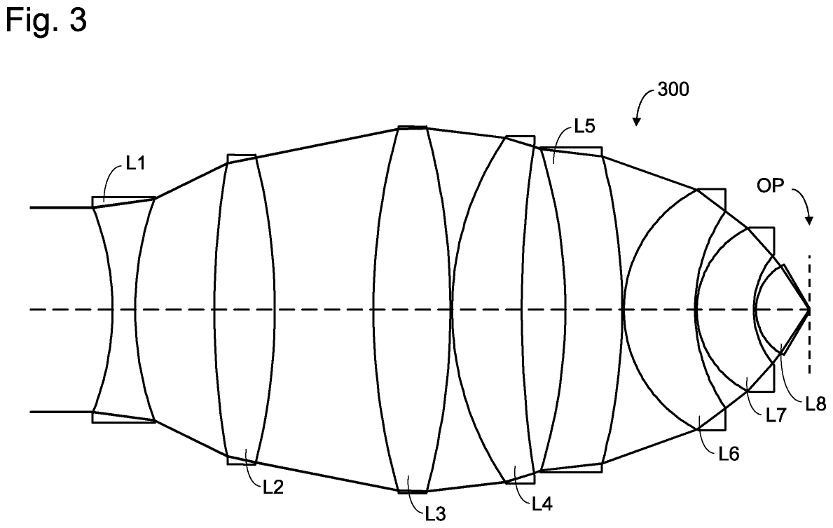

This meniscus lens, both in the design in FIGS. 1A and 1n the designs in FIGS. 2-4, is arranged in each case at a position at which the marginal ray height is greater than 70%, in particular greater than 75%, of the maximum marginal ray height. In the exemplary embodiment in FIG. 1A, this marginal ray height at the position of the meniscus lens is 96%.

The two lenses L8 and L9 have a characteristic aplanatic lens geometry and deflect the light (to produce aberrations as little as possible) to the final focus with the smallest possible angles of incidence and reflection.

A further feature of the microscope objective 100 in FIG. 1A is the comparatively large “working distance” between the object plane OP and the last optical element on the object plane side, which is 4.0 mm in accordance with Table 1; this may also allow an arrangement of a pellicle (used for protecting the mask) in this region.

FIG. 1C shows—proceeding from the microscope objective 100 described above with reference to FIG. 1A—an overall system in which the microscope objective 100 is used in conjunction with a tube system 150. The tube system 150 comprises (starting from the left once again merely for the purposes of the description) a diverging first lens group 110 composed of two lenses 111, 112 and a converging lens group 120 composed of two lenses 121, 122, which has a collimating effect. During practical operation (i.e., use for mask characterization), the tube system 150 has the effect that the imaging “towards infinity” performed by the microscope objective 100 with a high numerical aperture NA on the object plane side (i.e., with high resolution) initially in collimation is imaged “into infinity” with a comparatively high magnification (300× in the exemplary embodiment) onto a detector. The tube system 150 is designed in such a way that it precisely compensates for the transverse chromatic aberration of the microscope objective 100.

FIG. 1B shows, for the microscope objective from FIG. 1A, an achievable PSF profile or the diffraction pattern of a point in the field center of the image field (so-called “Airy disc”). The dashed line corresponds to the diffraction pattern for perfectly monochromatic light, whereas the solid line corresponds to the diffraction pattern when using light having a full bandwidth (FWHM=full width at half maximum) of approximately 2 pm. FIG. 1B reveals that the contrast decreases by only a few percent (from 100% to almost 95%) at the maximum as a result of the chromatic imaging aberrations present.

Although for the sake of simplicity for each of the embodiments described below with reference to FIG. 2 to FIG. 4, the illustration of such a tube system is dispensed with, this system can be realized straightforwardly in an analogous manner in each case substantially analogously to FIG. 1C for each of the corresponding microscope objectives.

What the embodiments described with reference to FIG. 1A to FIG. 4 have in common is that the microscope objective respectively shown is designed for light having a bandwidth (FWHM) of less than 5 pm (less than 2 pm in accordance with FIGS. 2-4). As already explained, this means that it is only for light with a spectral bandwidth (FWHM) of less than 5 pm that the so-called Strehl number (also referred to as Strehl ratio or Strehl intensity ratio) reaches a value of at least 80% (so that the optical system can still be regarded as substantially diffraction-limited).

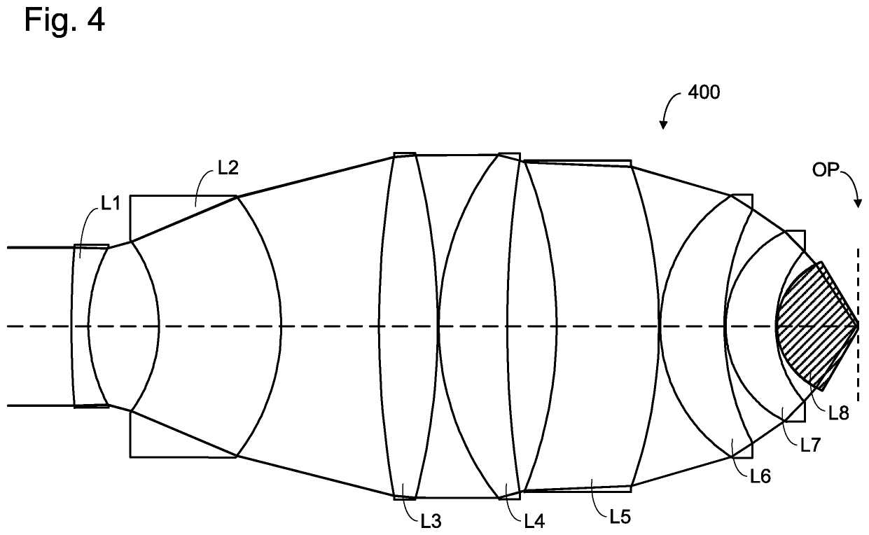

The respective value of the Strehl number for light having a bandwidth (FWHM) of 2 pm is 94% for the design in FIG. 1A, 80% for the design in FIG. 2, 95% for the design in FIG. 3, and 92% for the design in FIG. 4. The respective value of the Strehl number for light having a bandwidth (FWHM) of 5 pm is 70% for the design in FIG. 1A, 51% for the design in FIG. 2, 75% for the design in FIG. 3, and 65% for the design in FIG. 4.

FIG. 1D shows a schematic illustration for explaining the possible construction of a device comprising a microscope objective in accordance with FIG. 1A and also a light source, where “103” denotes a beam splitter and “102” denotes a condenser lens. In FIG. 1E, just a corresponding source spectrum is schematically indicated.

FIG. 2 shows a microscope objective 200 as a further exemplary embodiment. The associated design data of the microscope objective 200 are given in Table 2.

The microscope objective 200 in accordance with FIG. 2 has a total of nine lenses L1-L9 composed of calcium fluoride (CaF₂). In the case of the microscope objective 200 in accordance with FIG. 2, the numerical aperture is increased to NA=1.20 in comparison with FIG. 1A. For this purpose, an immersion medium is introduced in the region between the last lens L9 on the object plane side and the object plane (OP). The immersion-side surface of the last lens L9 on the object plane side is designed as a plane surface. In the exemplary embodiment, the immersion medium is perfluoropolyether (PFPE), which has a refractive index of n≈1.37 at a wavelength of 157 nm. In order to limit the absorption taking place in the immersion medium, the thickness of the liquid film corresponding to the immersion medium is preferably 1 mm or less as in the exemplary embodiment. Furthermore, the immersion-side surface of the last lens L9 on the object plane side is preferably protected by a suitable coating against a chemical interaction with the immersion medium.

The two lenses L7 and L8 in the microscope objective 200 have—in this respect analogously to FIG. 1A—a characteristic aplanatic lens geometry, wherein they deflect the light, in order to minimize aberrations, to the final focus with the smallest possible angles of incidence and reflection.

Furthermore, the microscope objective 200 in accordance with FIG. 2, once again for the correction of aberrations (primarily spherical aberration), has two lenses L3 and L6 configured as meniscus lenses, which are arranged in the beam path in such a way that comparatively high angles of incidence occur on the respective concave lens side. The lens L6 is configured to be convex on the object plane side and the lens L3 is configured to be convex on the image plane side. In the exemplary embodiment in FIG. 2, the marginal ray height at the position of the meniscus lens L6 is 92%.

Furthermore—and once again when viewed starting from the left—firstly a diverging lens group composed of two lenses L1, L2 having overall negative refractive power is provided, whereby a significant increase in the cross-section of the beam is effected in a manner comparable with FIG. 1A.

FIG. 3 shows a further exemplary embodiment of a microscope objective 300, in which a further increase in the numerical aperture NA to a value of NA=1.20 is achieved. The associated design data are given in Table 3.

The microscope objective 300 in accordance with FIG. 3 has a total of eight lenses L1-L8 composed of calcium fluoride (CaF₂).

The further increase in the numerical aperture NA is achieved in the exemplary embodiment in FIG. 3 by virtue of the fact that, according to the “solid immersion” concept known per se, between a last optical surface of the microscope objective 300 on the object plane side and the object plane OP there is a distance in the range from zero to λ, in particular in the range from zero to λ/2, more particularly in the range from zero to λ/5, wherein λ denotes the wavelength of the electromagnetic radiation used. In the concrete exemplary embodiment in FIG. 3, this distance is zero.

Furthermore, in the case of the microscope objective 300, the last lens L8 on the object plane side is conically configured or ground for the purpose of minimizing the cross-sectional area in order to avoid a risk of collision (which would exist given a larger, plane surface of the lens L8 on the object plane side) in view of the comparatively small working distance of only a few 10 nanometers, including in the presence of a topographical unevenness (e.g., of several 10 or 100 nanometers) on the object to be examined.

Furthermore, analogously to FIG. 1A, the lens L5 situated in the region of the maximum lens diameters is configured as a meniscus lens that is convex on the object plane side, and this lens is primarily used to correct spherical aberration. In the exemplary embodiment in FIG. 3, the marginal ray height at the position of the meniscus lens L5 is 89%.

FIG. 4 shows as a further exemplary embodiment a microscope objective 400, in which the numerical aperture is again significantly increased to a value of NA=1.80.

The further increase in the numerical aperture (NA) is achieved in the exemplary embodiment in FIG. 4 and the associated Table 4 once again proceeding from the abovementioned “solid immersion” concept by using a high refractive index material in the lens L8 closest to the object plane side. In the exemplary embodiment in FIG. 4, the lens L8 is composed of lutetium aluminium garnet (Lu₃Al₅O₁₂, LuAG). A further high refractive index material that is suitable by way of example is spinel (MgAl₂O₄).

The microscope objective 400 in accordance with FIG. 4 comprises a total of eight lenses L1 to L8, which are produced from calcium fluoride (CaF₂) with the exception of the aforementioned lens L8.

In this case, analogously to FIG. 1A, the lens L5 situated in the region of the maximum lens diameters is configured as a meniscus lens that is convex on the object plane side, and this lens is primarily used to correct spherical aberration. In the exemplary embodiment in FIG. 4, the marginal ray height at the position of the meniscus lens L5 is 96%.

TABLE 1
(relating to FIG. 1A)

| | | | |
|---|---|---|---|
| EBR/mm | 8 | | |
| ANG/deg | 1 | | |
| EFL/mm | 10 | | |
| WL/nm | 157.00 | 156.00 | 158.00 |

| | | | | | | | Half- |
|---|---|---|---|---|---|---|---|
| Surface | Radius | Thickness | Material | n(157.00) | n(156.00) | n(157.10) | diameter |
| 0 | 0.000000 | infinite | | | | | |
| 1 | 41.379905 | 3.377413 | CAF2 | 1.555560 | 1.557892 | 1.553293 | 8.5 |
| 2 | −70.912334 | 0.303561 | | | | | 8.3 |
| 3 | 27.634570 | 8.355678 | CAF2 | 1.555560 | 1.557892 | 1.553293 | 7.9 |
| 4 | 8.619765 | 8.525207 | | | | | 5.7 |
| 5 | −7.072095 | 5.228142 | CAF2 | 1.555560 | 1.557892 | 1.553293 | 6.0 |
| 6 | −51.031693 | 2.336763 | | | | | 10.0 |
| 7 | −25.887482 | 6.137690 | CAF2 | 1.555560 | 1.557892 | 1.553293 | 10.7 |
| 8 | −14.714586 | 0.298901 | | | | | 12.1 |
| 9 | 403.041115 | 5.829706 | CAF2 | 1.555560 | 1.557892 | 1.553293 | 14.4 |
| 10 | −32.092318 | 0.299134 | | | | | 13.1 |
| 11 | 38.376273 | 6.027605 | CAF2 | 1.555560 | 1.557892 | 1.553293 | 15.0 |
| 12 | −111.979221 | 3.782580 | | | | | 14.8 |
| 13 | −29.710025 | 3.492394 | CAF2 | 1.555560 | 1.557892 | 1.553293 | 14.5 |
| 14 | −33.923098 | 0.299429 | | | | | 14.6 |
| 15 | 28.764950 | 5.108118 | CAF2 | 1.555560 | 1.557892 | 1.553293 | 13.1 |
| 16 | 1668.252229 | 0.299760 | | | | | 12.5 |
| 17 | 11.441140 | 6.882669 | CAF2 | 1.555560 | 1.557892 | 1.553293 | 9.6 |
| 18 | 27.134624 | 1.515343 | | | | | 7.4 |
| 19 | 0.000000 | 1.900000 | CAF2 | 1.555560 | 1.557892 | 1.553293 | 6.8 |
| 20 | 0.000000 | 4.000000 | | | | | 5.6 |
| 21 | 0.000000 | 0.000000 | | | | | 0.3 |

TABLE 2
(relating to FIG. 2)

| | | | |
|---|---|---|---|
| NA | 1.2 | | |
| GIH/mm | 0.01 | | |
| EFL/mm | 10.75 | | |
| WL/nm | 157.00 | 156.90 | 157.10 |

| | | | | | | | Half- |
|---|---|---|---|---|---|---|---|
| Surface | Radius | Thickness | Material | n(157.00) | n(156.90) | n(157.10) | diameter |
| 0 | 0.000000 | infinite | | | | | |
| 1 | −18.164870 | 2.000000 | CAF2 | 1.555560 | 1.555790 | 1.555331 | 9.4 |
| 2 | 32.773203 | 5.415038 | | | | | 10.8 |
| 3 | −39.063431 | 4.195032 | CAF2 | 1.555560 | 1.555790 | 1.555331 | 11.9 |
| 4 | −26.500203 | 17.732657 | | | | | 13.3 |
| 5 | 116.148625 | 4.999805 | CAF2 | 1.555560 | 1.555790 | 1.555331 | 25.6 |
| 6 | 90.332485 | 2.875304 | | | | | 26.8 |
| 7 | 205.547624 | 15.929502 | CAF2 | 1.555560 | 1.555790 | 1.555331 | 27.2 |
| 8 | −39.378373 | 0.150108 | | | | | 27.9 |
| 9 | 48.644764 | 12.526257 | CAF2 | 1.555560 | 1.555790 | 1.555331 | 26.6 |
| 10 | −163.132626 | 2.931230 | | | | | 26.0 |
| 11 | −76.661180 | 4.999853 | CAF2 | 1.555560 | 1.555790 | 1.555331 | 25.6 |
| 12 | −213.805823 | 0.137287 | | | | | 24.3 |
| 13 | 26.741961 | 7.742780 | CAF2 | 1.555560 | 1.555790 | 1.555331 | 20.4 |
| 14 | 44.514144 | 0.149737 | | | | | 18.9 |
| 15 | 18.408788 | 7.301062 | CAF2 | 1.555560 | 1.555790 | 1.555331 | 15.7 |
| 16 | 18.989589 | 0.179345 | | | | | 12.7 |
| 17 | 12.226216 | 14.004876 | CAF2 | 1.555560 | 1.555790 | 1.555331 | 10.8 |
| 18 | 0.000000 | 1.000000 | PFPE | 1.370000 | 1.370000 | 1.370000 | 1.8 |
| 19 | 0.000000 | 0.000000 | | | | | 0.0 |

TABLE 3
(relating to FIG. 3)

| | | | |
|---|---|---|---|
| EBR/mm | 9 | | |
| GIH/mm | 0.01 | | |
| EFL/mm | 10.75 | | |
| WL/nm | 157.00 | 156.90 | 157.10 |

| | | | | | | | Half- |
|---|---|---|---|---|---|---|---|
| Surface | Radius | Thickness | Material | n(157.00) | n(156.90) | n(157.10) | diameter |
| 0 | 0.000000 | infinite | | | | | |
| 1 | −24.539335 | 2.000000 | CAF2 | 1.555560 | 1.555790 | 1.555331 | 9.0 |
| 2 | 29.246494 | 6.958923 | | | | | 9.8 |
| 3 | 73.719544 | 5.317864 | CAF2 | 1.555560 | 1.555790 | 1.555331 | 12.9 |
| 4 | −55.033409 | 8.674878 | | | | | 13.5 |
| 5 | 58.869835 | 6.795626 | CAF2 | 1.555560 | 1.555790 | 1.555331 | 16.0 |
| 6 | −62.168868 | 0.137287 | | | | | 16.0 |
| 7 | 26.857877 | 6.123425 | CAF2 | 1.555560 | 1.555790 | 1.555331 | 15.2 |
| 8 | 97.076450 | 3.845289 | | | | | 14.4 |
| 9 | −47.352685 | 4.998357 | CAF2 | 1.555560 | 1.555790 | 1.555331 | 14.2 |
| 10 | −53.387461 | 0.149646 | | | | | 13.5 |
| 11 | 11.868701 | 6.266164 | CAF2 | 1.555560 | 1.555790 | 1.555331 | 10.6 |
| 12 | 15.469326 | 0.149777 | | | | | 8.7 |
| 13 | 7.957412 | 5.011232 | CAF2 | 1.555560 | 1.555790 | 1.555331 | 7.2 |
| 14 | 7.561653 | 0.149609 | | | | | 4.7 |
| 15 | 4.111717 | 4.728734 | CAF2 | 1.555560 | 1.555790 | 1.555331 | 3.7 |
| 16 | 0.000000 | 0.000000 | | | | | 0.0 |

TABLE 4
(relating to FIG. 4)

| | | | |
|---|---|---|---|
| NA | 1.8 | | |
| GIH/mm | 0.01 | | |
| EFL/mm | 10.75 | | |
| WL/nm | 157.00 | 156.90 | 157.10 |

| | | | | | | | Half- |
|---|---|---|---|---|---|---|---|
| Surface | Radius | Thickness | Material | n(157.00) | n(156.90) | n(157.10) | diameter |
| 0 | 0.000000 | infinite | | | | | |
| 1 | 120.820778 | 2.000000 | CAFUV | 1.555560 | 1.555790 | 1.555331 | 9.3 |
| 2 | 19.675319 | 8.202735 | | | | | 9.2 |
| 3 | −16.785742 | 14.209224 | CAFUV | 1.555560 | 1.555790 | 1.555331 | 9.9 |
| 4 | −24.646723 | 11.368086 | | | | | 15.1 |
| 5 | 113.028461 | 6.831261 | CAFUV | 1.555560 | 1.555790 | 1.555331 | 19.8 |
| 6 | −78.533620 | 0.137287 | | | | | 20.0 |
| 7 | 32.441496 | 7.932238 | CAFUV | 1.555560 | 1.555790 | 1.555331 | 20.0 |
| 8 | 128.352197 | 5.751080 | | | | | 19.3 |
| 9 | −51.586142 | 11.917525 | CAFUV | 1.555560 | 1.555790 | 1.555331 | 19.1 |
| 10 | −55.588065 | 0.149806 | | | | | 18.6 |
| 11 | 18.185727 | 7.452145 | CAFUV | 1.555560 | 1.555790 | 1.555331 | 15.2 |
| 12 | 30.053990 | 0.149926 | | | | | 13.7 |
| 13 | 12.282455 | 5.838162 | CAFUV | 1.555560 | 1.555790 | 1.555331 | 11.0 |
| 14 | 13.321724 | 0.149935 | | | | | 8.8 |
| 15 | 7.998079 | 9.198580 | LUAG | 2.150000 | 2.150000 | 2.150000 | 7.2 |
| 16 | 0.000000 | 0.000000 | | | | | 0.0 |

Even though the invention has been described on the basis of specific embodiments, numerous variations and alternative embodiments are evident to a person skilled in the art, e.g., through combination and/or exchange of features of individual embodiments. Accordingly, it goes without saying for a person skilled in the art that such variations and alternative embodiments are also encompassed by the present invention, and the scope of the invention is restricted only within the meaning of the accompanying patent claims and the equivalents thereof.

What is claimed is:

1. A microscope objective, in particular for a device for determining the position of structures on a mask for microlithography,
wherein the microscope objective is designed for an operating wavelength (λ) of less than 190 nm and for light having a bandwidth of less than 5 pm,
wherein the object-side numerical aperture (NA) of the microscope objective is at least 0.8; and
wherein at least one meniscus lens is provided for at least partial correction of the spherical aberration.

2. The microscope objective according to claim 1, wherein the microscope objective is designed for light having a bandwidth of less than 2 pm.

3. The microscope objective according to claim 1, wherein said at least one meniscus lens is arranged at a position at which the marginal ray height is greater than 70%, in particular greater than 75%, of the maximum marginal ray height.

4. The microscope objective according to claim 1, wherein it is designed for an operating wavelength (λ) of less than 180 nm, in particular less than 170 nm, more particularly less than 160 nm.

5. The microscope objective according to claim 1, wherein the object-side numerical aperture (NA) of the microscope objective is at least 1.0, in particular at least 1.2.

6. The microscope objective according to claim 1, wherein it has an immersion medium between the last lens on the object plane side and the object plane (OP), said immersion medium having a refractive index of at least 1.3 at the operating wavelength (λ).

7. The microscope objective according to claim 6, wherein the immersion medium is perfluoropolyether (PFPE).

8. The microscope objective according to claim 1, wherein it has a last lens on the object plane side composed of a material which has a refractive index of at least 1.8, in particular at least 2.0, at the operating wavelength.

9. The microscope objective according to claim 1, wherein between a last optical surface of the microscope objective on the object plane side and the object plane (OP) there is a distance of in the range from zero to λ, in particular in the range from zero to λ/2, more particularly in the range from zero to λ/5, wherein λ denotes the wavelength of the electromagnetic radiation used.

10. The microscope objective according to claim 1, wherein it exclusively comprises a single optical material.

11. The microscope objective according to claim 1, wherein it has a dioptric construction.

12. A device for determining the position of structures on a mask for microlithography, wherein the device comprises a microscope objective according to claim 1.

13. The device according to claim 12, wherein it comprises a light source having a bandwidth of less than 5 pm, in particular less than 2 pm.

14. The device according to claim 12 wherein the at least one meniscus lens is arranged at a position at which the marginal ray height is greater than 70% of the maximum marginal ray height.

15. The device according to claim 12 wherein the microscope objective is designed for an operating wavelength (λ) of less than 180 nm.

16. The device according to claim 12 wherein the object-side numerical aperture (NA) of the microscope objective is at least 1.0.

17. The device according to claim 12 wherein the microscope objective has an immersion medium between the last lens on the object plane side and the object plane (OP), the immersion medium having a refractive index of at least 1.3 at the operating wavelength (λ).

18. The device according to claim 17 wherein the immersion medium comprises perfluoropolyether (PFPE).

19. The device according to claim 12 wherein the microscope objective has a last lens on the object plane side composed of a material which has a refractive index of at least 1.8 at the operating wavelength.

20. The device according to claim 12 wherein between a last optical surface of the microscope objective on the object plane side and the object plane (OP) there is a distance of in the range from zero to λ, wherein λ denotes the wavelength of the electromagnetic radiation used.

21. The device according to claim 12 wherein the microscope objective exclusively comprises a single optical material.
